(19) United States
(12) Patent Application Publication
(10) Pub. No.: US 2023/0351569 A1
(43) Pub. Date: Nov. 2, 2023

(54) CONJUGATE IMAGE FOR COLOR AND NEAR-INFRARED IMAGE FUSION

(71) Applicant: INNOPEAK TECHNOLOGY, INC., Palo Alto, CA (US)

(72) Inventors: Kim Chai Ng, Palo Alto, CA (US); Jinglin Shen, Palo Alto, CA (US); Chiu Man Ho, Palo Alto, CA (US)

(21) Appl. No.: 18/139,061

(22) Filed: Apr. 25, 2023

Related U.S. Application Data
(63) Continuation of application No. PCT/US2021/032486, filed on May 14, 2021.
(60) Provisional application No. 63/113,151, filed on Nov. 12, 2020.

(51) Int. Cl. G06V 10/60; G06T 5/50; G06V 10/56

(52) U.S. Cl. CPC G06T 5/50; G06V 10/56; G06V 10/60; G06T 2207/10024; G06T 2207/10048; G06T 2207/20221

(57) ABSTRACT

In various embodiments, an image processing method is provided. In those embodiments, a first image and a second image are obtained. A conjugate image is obtained based on the second image. In the conjugate image, a given pixel has a luminance less than a corresponding pixel in the second image. In those embodiments, a weight is obtained based on the conjugate image. During an image fusion of the first and the second image, the weight is applied - for example for assigning percentages of luminance coming from the first and second images. In those embodiments, as a result of the weight, for certain parts like vegetation, the fused image is biased towards the color image, while for some other parts, the fused image is biased towards the NIR image. Other embodiments may include computer systems, apparatus, and computer programs stored storage medium, each configured to perform the image processing method.

### CROSS-REFERENCE TO RELATED APPLICATIONS

This application a continuation of International Application No. PCT/US2021/032486, filed on May 14, 2021, which claims priority to U.S. Provisional Application No. 63/113,151, entitled “Color Image & Near-Infrared Image Fusion with Base-Detail Decomposition and Flexible Color and Details Adjustment” filed on Nov. 12, 2020. The disclosures of the aforementioned applications are hereby incorporated by reference in their entireties.

### TECHNICAL FIELD

This disclosure relates generally to electronically-implemented methods and systems for computer image processing, more particularly to image fusion.

### BACKGROUND

Image fusion is a process of combining information from different sources of images into an image. A purpose of image fusion is not only to reduce an amount of data of the images but also to construct the fused image more appropriate and understandable for human and machine perception. In computer vision, multi-sensor image fusion is a process of combining relevant information from two or more images into a single image or fused image. The fused image may contain more information than any of the input images.

One active research area in image fusion is fusing color images with Near-Infrared (NIR) images. In general, efforts in this research area are to increase details of color image from the extra information of NIR while preserving color and brightness of the color image. For example, color and NIR image fusion is used to de-haze a scene so to see through a fog and/or haze captured in an original color image.

### SUMMARY

An innovative concept called conjugate image is provided herein to fix deviations in a fused imaged based on an NIR image. In some embodiments, the conjugate image is applied to a fused image in a form of a weight or weight function to preserve the colors and details of the vegetation in the fused image. In those embodiments, vegetation colors, brightness, and/or any other details in the fused image are weighted towards the color image, while non-vegetation parts in the fused image are weighted towards the NIR image.

In some embodiments, a device can be configured to perform particular operations or actions by virtue of having software, firmware, hardware, or a combination of them installed on the device that in operation causes or cause the device to perform the actions. One or more computer programs can be configured to perform particular operations or actions by virtue of including instructions that, when executed by the device, cause the device to perform the actions. One general aspect in those embodiments includes an electronically-implemented image processing method. The electronically-implemented image processing method may include obtaining a first image and a second image, where both the first image and the second image include a scene. The first image comprises a first pixel and the second image comprises a second pixel. The first pixel corresponds to the second pixel such that both pixels correspond to a same part in the scene. The electronically-implemented image processing method may include a conjugate image based on the second image. A third pixel in the conjugate image corresponds to the second pixel in the second image, and a luminance of the third pixel is less than a luminance of the second pixel.

In those embodiments, the electronically-implemented image processing method may include obtaining a weight based on the conjugate image, and using the first and second images to produce the fused image based on the weight. In those embodiments, as a result of the weight, the fusing is biased towards the third pixel in the conjugate image in color, luminance and/or any other aspects rather than the second pixel in the second image. Other embodiments may include corresponding computer systems, apparatus, and computer programs stored on one or more computer storage devices, each configured to perform the electronically-implemented image processing method.

Various embodiments may include one or more of the following features. In some embodiments, the first image is a color image and the second image is an NIR image. In some embodiments, the electronically-implemented imaging processing method may include converting the first image to a L*a*b* color space, where L* represents the luminance of the first image, and a* and b* represent colors of the first image. In some embodiments, at the third pixel in the conjugate image, a luminance of third pixel is obtained by dividing a square of a luminance of the first pixel in the first image using a luminance of the second pixel.

In some embodiments, for the part in the scene, a difference (conjugateDiff) between the color image and conjugate image in luminance is obtained. In those embodiments, the fusing includes: for the part in the scene in the fused image, using conjugateDiff as the luminance. In those embodiments, the conjugateDiff is obtained by subtracting the luminance of the third pixel in the conjugate image from the luminance of the first pixel in the first image.

In some embodiments, for obtaining the weight based on the conjugate image, an infrared emission difference (irDiff) between the first image and the second image is obtained; a difference (conjugateDiff) between the color image and conjugate image in luminance is obtained; and a difference (irConjugateDiff) between conjugateDiff and irDiff is obtained. In those embodiments, the fusing includes applying the irConjugateDiff as a weight.

In some embodiments, an inverted irConjugateDiff is obtained. In those embodiments, the fusing includes using irConjugateDiff and inverted irConjugateDiff as weights according to the following formula:

$$\left(1 - i r C o n j u g a t e D i f f\right) * L 1 + i r C o n j u g a t e D i f f * L 2$$

L1 represents a luminance of the first pixel in the first image, and L2 represents a luminance of the second pixel in the second image.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE DRAWINGS

Features, embodiments, and advantages of the present disclosure are better understood when the following Detailed Description is read with reference to the accompanying drawings.

FIG. 1A shows a color image of a scene.

FIG. 1B shows a near-infrared (NIR) image of the scene shown FIG. 1A.

FIG. 1C shows a fused image obtained by fusing images shown in FIGS. 1A and 1B.

FIG. 2 illustrates an example device employing a Conjugate Image fusion method in accordance with some embodiments of the present disclosure.

FIG. 3, illustrates an example conjugate image fusion method in accordance with some embodiments of the present disclosure.

FIG. 4A shows another NIR image of a scene.

FIG. 4B shows an example imaged obtained based on the NIR image of the scene shown in FIG. 4A as an irDiff between the NIR image and the color image shown in FIG. 1A.

FIG. 4C shows an example of a conjugate image obtained based on the NIR image shown in FIG. 4A.

FIG. 4D shows an example image obtained as conjugateDiff from the color image shown in FIG. 1A and the conjugate image shown in FIG. 4C.

FIG. 4E shows an example of irConjugateDiff obtained based the irDiff shown in FIG. 4B and the conjugate image shown in FIG. 4C.

FIG. 4F shows one example of an image obtained through an inverted irConjugateDiff.

FIG. 5A shows another color image of a scene.

FIG. 5B shows one example of a fused image obtained by applying irDiff as a binary weight to enhance the color image shown in FIG. 5A in accordance with some embodiments of the present disclosure.

FIG. 5C shows one example of a fused image by using conjugateDiff in accordance with some embodiments of the present disclosure.

FIG. 5D shows one example of a fused image by using irConjugateDiff and inverted irConjugateDiff as weights in accordance with some embodiments of the present disclosure.

FIG. 6A illustrates one example method for obtaining a weight based a conjugate image in accordance with some embodiments of the present disclosure.

FIG. 6B illustrates another example method for obtaining a weight based a conjugate image in accordance with some embodiments of the present disclosure.

FIG. 6C illustrates yet another example method for obtaining a weight based a conjugate image in accordance with some embodiments of the present disclosure.

FIG. 7 illustrates example details of the processor shown in FIG. 2 in accordance with some embodiments of the present disclosure.

FIG. 8 depicts an example of a computing device that can implement the device shown in FIG. 2 in accordance with some embodiments of the present disclosure.

### DETAILED DESCRIPTION

As used herein a color image may be referred to as an image captured by an image senor and created by a color filter. An RGB (red, green, blue) image is a type of color image. However, color images are not necessary only limited to RGB images. Other types of color images are also contemplated and within the scope of the present disclosure.

As used herein, a fused image may be referred to an output image from two or more images. It is understood that a fused image in accordance with the disclosure is not necessarily limited to a final output image - for example to be perceived by a human. Any output images including intermediate images for producing a final output image are within the scope of the fused image in accordance with the present disclosure so long as they are created by fusing two or more images.

As used here, in a near-infrared (NIR) image may be referred to as an image captured by an NIR sensor. NIR is a subset of the infrared band of the electromagnetic spectrum. These wavelengths are just outside the range of what humans can see and can sometimes offer clearer details than what is achievable with visible light imaging. A specific range of the NIR wavelengths is not intended to be limited by the present disclosure. Several benefits of NIR imaging are described below and thus imaging fusion method using various principles to enhance the fused image described herein are within the scope of the present disclosure.

As mentioned above, NIR is very close to human vision but removes the color wavelengths, which results in most objects in the NIR image looking very similar to an image that has been converted to black and white. One exception is trees and plants, which are highly reflective in the NIR wavelength and thus appear much brighter than they do in color. That difference in reflectivity of certain objects, in combination with reduced atmospheric haze and distortion in the NIR wavelength, means that detail and visibility are often improved at long ranges for NIR enhanced images.

One benefit of NIR imaging is that the longer wavelengths of the NIR spectrum are able to penetrate haze, light fog, smoke and other atmospheric conditions better than visible light. For long-distance imaging, this often results in a sharper, less distorted image with better contrast than what can be seen with visible light.

Another benefit of NIR imaging is that, unlike thermal energy which displays objects quite differently from visual perception, NIR is a reflected energy that behaves similar to visible light, which means that it can see things like printed information on signs, vehicles and vessels that thermal imaging usually cannot. Faces, clothing and many other objects will also look more natural and recognizable than they do in thermal.

In various embodiments, devices with imaging capabilities may be configured to capture color images and NIR images of a same scene or more or less the same scene simultaneously (or near simultaneously) and separately. For example, such devices may include a smartphone equipped with a color image sensor and a NIR senor. In that example, the color image sensor and the NIR sensor may be controlled (for example by a camera app on the smartphone) to capture a color image and a NIR image of the scene simultaneously. Typically, the so captured color image and NIR image differ in color, brightness, details and/or any other aspects for various reasons explained herein. In that example, the camera app on the smartphone may be configured to employ one or more image fusion methods in accordance with the present disclosure to enhance the color image by fusing the color image and NIR image. For example, details provided by the NIR image may be added to the color image through the image fusion.

However, one drawback with many existing image fusion methods that fuse color image and NIR image is that the resulting color in the fused image typically deviates from that in the color image. Under those existing image fusion methods, the fused image thus may not look natural or its color may appear to be wrong when perceived by human.

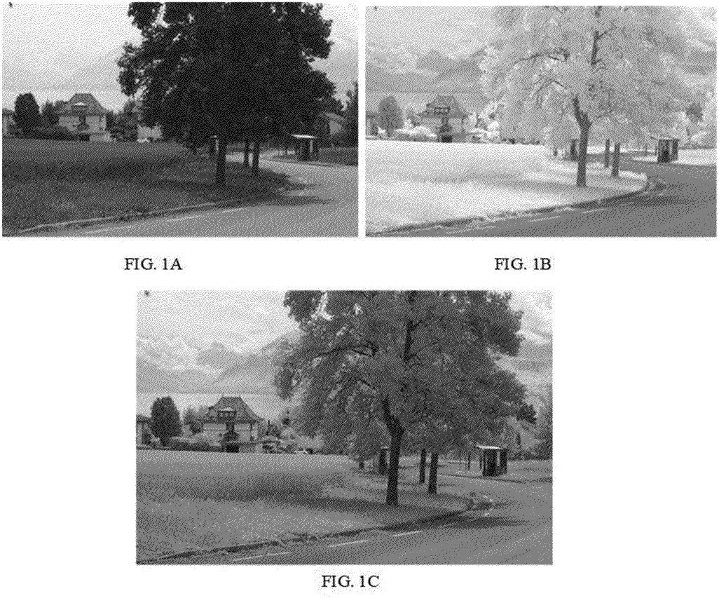

FIG. 1C illustrate a fused imaged using an existing image fusion method may appear to be wrong. As shown in FIG. 1A, a color image of a scene with a tree in the foreground is captured. FIG. 1B shows a NIR image of the same scene is also captured. FIG. 1C shows the fused image is obtained by averaging the two images in luminance channel and merged back with color channels of the color image. As can be seen, while the fused image in FIG. 1C does provide a clearer background than the color image shown in FIG. 1A, the brightness and color of the tree in the fused image appear to deviate quite a bit from the color image shown in FIG. 1A. Thus, in FIG. 1C, the tree does not look natural in the fused image when perceived by human. As mentioned above, green plants, such as the tree in the images, have stronger IR emissions than some other objects, for example, the paved road in the images shown in FIGS. 1A-C. Thus, in this example, the simple fusion of the color image and NIR image results in the vegetation colors (e.g., trees and grasses) can become much more prominent than they are supposed to be in the fused image.

To address this problem, inventor(s) of the present disclosure has come up a number of innovative ways to fuse color images and NIR images to reduce the color/brightness deviation in the fused image. In US Patent Application number #63/113,151, entitled “Color Image & Near-Infrared Image Fusion with Base-Detail Decomposition and Flexible Color and Details Adjustment”, the inventor(s) comes up a way of computing IR emission strength in the NIR image to adjust the color appearance of the fused image. In that application, the IR emission strength is derived from how much the NIR deviate from the brightness of the color image’s L channel’s. US Patent Application number #63/113,151 is incorporated herein in its entirety.

In accordance with the present disclosure, the inventor(s) has come up an innovative concept called Conjugate Image to fix the deviations in a fused imaged based on NIR. In accordance with the present disclosure, a Conjugate Image may be referred to an image having an opposite brightness characteristics as compared to a corresponding NIR image. In some embodiments, the Conjugate Image is coupled with an IR Emission Strength image and is applied to a fused image in a form of a weighting function to preserve the colors and details of the vegetation in the fused image. In those embodiments, vegetation colors in the fused image are weighted towards their colors in the color image, while non-vegetation parts in the fused image may be weighted towards their counterparts in the NIR image.

### I. Example Device

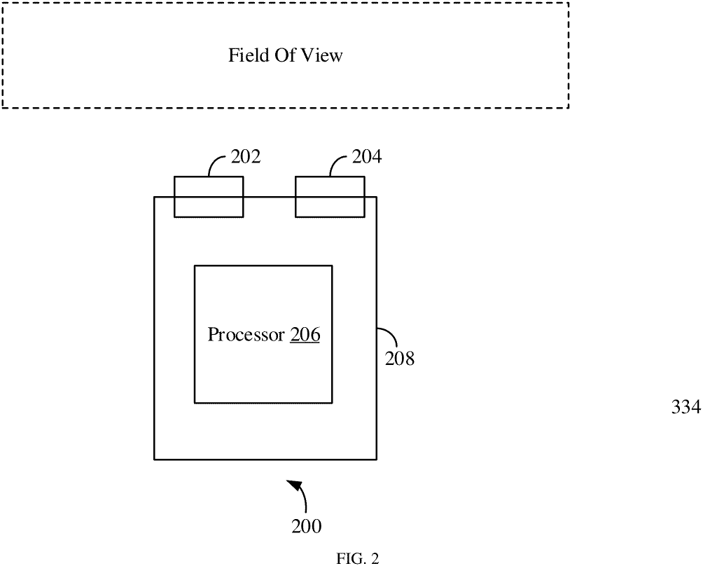

With an inventive concept in accordance with the present disclosure having been generally described, attention is now directed to FIG. 2, where an example device 200 employing a Conjugate Image fusion method in accordance with the present disclosure is illustrated. As shown in this example, the device 200 may include one or more of a sensor 202 capable of capturing a color image, for example a color imaging sensor, one or more of a sensor 204 capable of capturing a NIR image, one or more of a processor 206, a housing 208, and/or any other components. In this example, the sensor 202 and sensor 204 are positioned on the device 200 such that they can capture a same (or more or less the same) field of view under an instruction from the processor 206 as shown. In one example implementation, the device 200 is a smartphone. In some other implementations, the device 200 may include a laptop computer, a tablet computer, a desktop computer, a vision device, a game console, a set top box, and/or any other types of devices suitable to employ the Conjugate Image fusion method in accordance with the present disclosure.

It is understood that the arrangement of the sensor 202 and sensor 204 on a same device (e.g., the device 200) is not necessarily the only arrangement for color and NIR image sensors in accordance with the present disclosure. In some other embodiments, the sensor 202 (e.g., color) may be arranged on one device and the sensor 204 (e.g., NIR) may be arranged on another device. For example, in one embodiment, the sensor 202 may be mounted on an unmanned vehicle (UAV) and the sensor 204 may be mounted on a vision enhancing device separate and distinct from the UAV. In that embodiment, the UAV and vision enhancing device may be controlled to capture the same (or more or less the same) field of view at a same or different time.

As mentioned above, in this example, the sensor 202 and sensor 204 are positioned on the device 200 to cover the same (or more or less the same) field of view so that no view cropping is needed for the images captures by them when fused. In some implementations, sensor 202 and sensor 204 may be set to capture images of same (or more or less the same) resolutions. However, this is not intended to be limiting. It is understood that matching resolutions for images captured by the sensor 202 and sensor 204 are not required by the present disclosure. As also mentioned, the processor 206 may be configured to generate an instruction to cause the sensor 202 and sensor 204 to capture images of the field of view at the same (or more or less the same) time. After the images are captures, the images can be processed and fused into the fused image using a Conjugate Image fusion method in accordance with the present disclosure, which will be described in greater details in the following sections.

The following non-limiting example is provided to introduce some embodiments. In this example, the processor 206 may be configured to execute an image processing application, which can receive a first image and a second image for fusing and generating a fused image from these two images. For instance, the first image and the second image can both be digital photographs. The first image may be a RGB color image of a real-world scene captured by a regular color camera and the second image may be an NIR image of the real-world scene captured by an NIR camera. The two images may have overlapping fields of view of the real-world scene. In one embodiment, the two images may be captured simultaneously or nearly simultaneously by image sensors mounted in proximity on a device such as the device 200 shown in FIG. 2. For example, the device may be a smartphone equipped with a first image sensor capable of capturing a color image and a second image sensor capable of capturing a NIR image. However, this is merely illustrative, and thus not intended to be limiting. It is contemplated that a single image sensor may be capable of capturing a color image and a NIR image of a scene at the same time.

### II. Conjugate Image Fusion Method

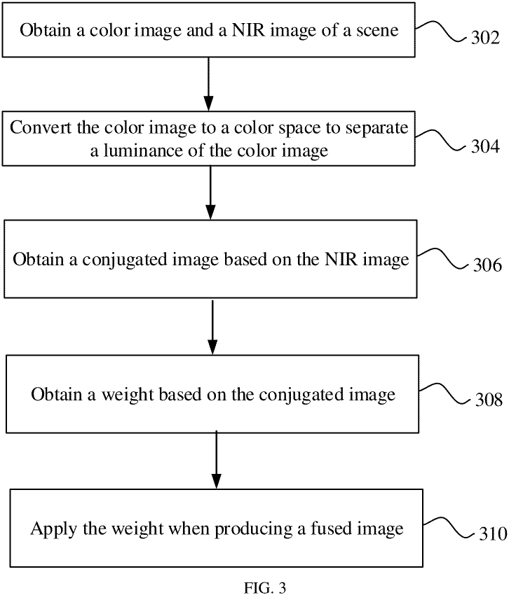

With an example device in accordance with the present disclosure having been generally described, attention is now directed to FIG. 3, where an example conjugate image fusion method 300 in accordance with the present disclosure is illustrated. The operations of method 300 presented below are intended to be illustrative. In some embodiments, method 300 may be accomplished with one or more additional operations not described and/or without one or more of the operations discussed. Additionally, the order in which the operations of method 300 are illustrated in FIG. 3 and described below is not intended to be limiting.

In some embodiments, method 300 may be implemented by a device including one or more of the processor, such as the ones shown in FIG. 2. The device may include a digital processor, an analog processor, a digital circuit designed to process information, an analog circuit designed to process information, a state machine, and/or other mechanisms for electronically processing information. The device may execute some or all of the operations of method 300 in response to instructions stored electronically on an electronic storage medium. The device may include one or more components configured through hardware, firmware, and/or software to be designed for execution of one or more of the operations of method 300.

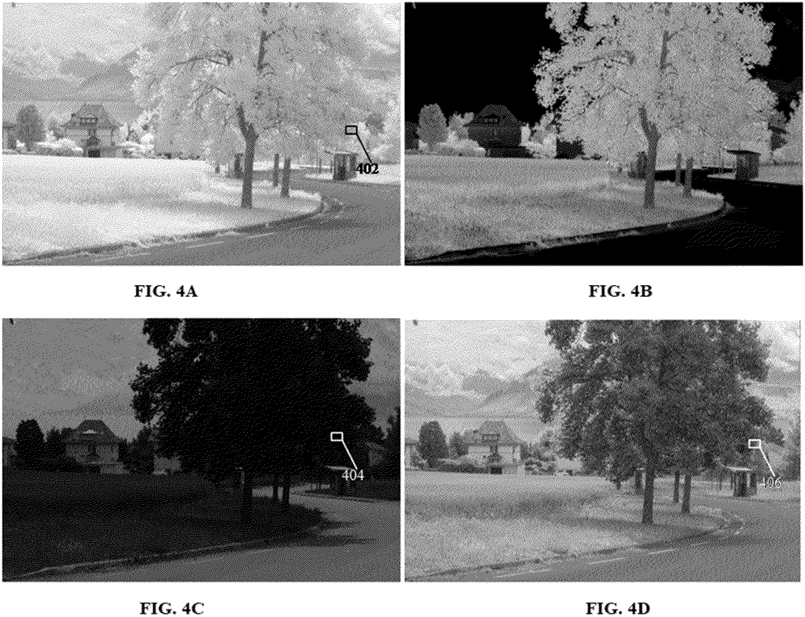

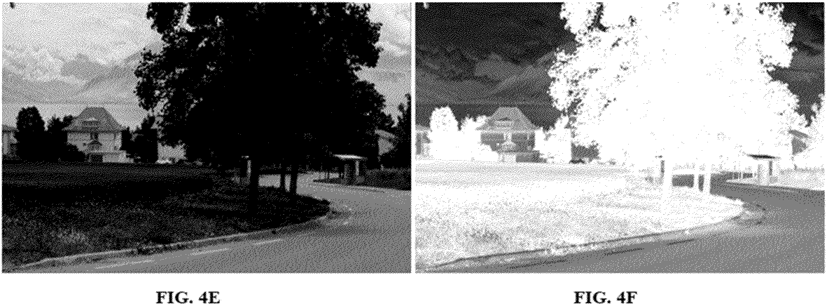

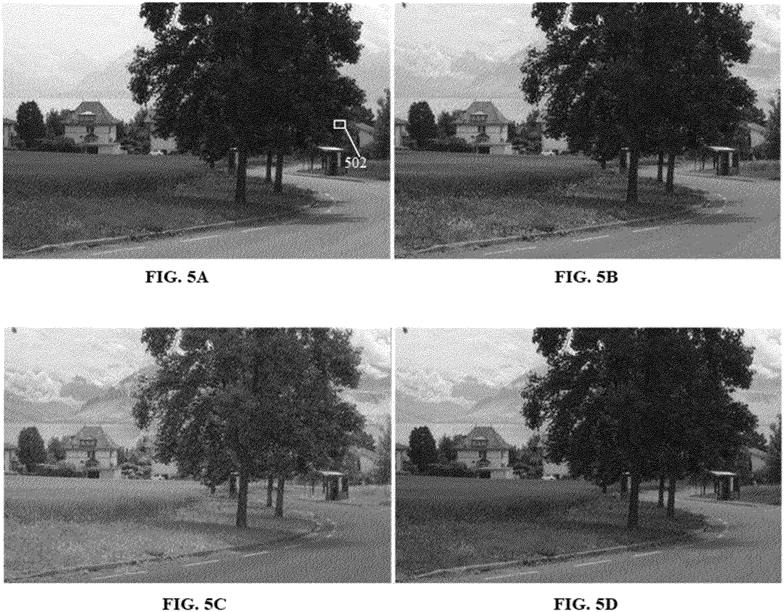

At 302, a color image and a NIR image of a scene can be obtained. As described herein, in some embodiments, the color image and NIR image of the scene may be captured by sensors on a device (such as a smartphone) at the same time or nearly at the same time. However, this is not necessarily the only case. In some embodiments, the color image and the NIR image may be obtained from a database, where those images of the scene are stored. Those images, in those embodiments, may or may not be captured at the same time. For example, it is contemplated that the color image of the scene of the image may be captured at a first time, and the NIR image of the scene may be captured at a second time separate and distinct from the first time. For instance, color images of a deep sea scene may be captured at the first time, and NIR images of the scene (or more or less of the scene) may be captured at a second time for enhancing the details captured in the color images. FIGS. 5A and 4A illustrate example color image and NIR image for a scene, respectively. As shown in FIG. 5A, a pixel 502 corresponds to a part of vegetation in a scene captured in the color image. FIG. 4A shows a pixel 402 corresponds to the same part of the vegetation in the scene in the NIR image.

At 304, the color image is converted into a color space that separates the colors in the color image from luminance in the color image. One example of such a color space is the CIELAB (International Commission on Illumination Lab) color space also referred to as L*a*b* color space. It expresses color as three values: L* for perceptual luminance, and a* and b* for four unique colors of human vision: red, green, blue, and yellow. However, it should be understood other color spaces are also contemplated.

At 306, a conjugate image is obtained based on the NIR image. An example of the conjugate image is illustrated in FIG. 4C. The term “conjugate image” in the context of present disclosure means such an image relates to the NIR image in that the conjugate image has color/brightness characteristics related to the NIR image. An insight by the inventor(s) of the present disclosure is that certain aspects of the NIR image, such as the brightness of vegetation parts in the NIR image, are not desired when the NIR image is fused with the color image. Thus, the inventor(s) of the present disclosure introduces this concept of conjugate image to reduce these aspects in the NIR image during the image fusion. As will be explained in further detail below, a weight may be obtained based on the conjugate image obtained at 308 and applied during the image fusion to reduce such an aspect in the fused image - for example, color/brightness deviation of the vegetation parts in the fused image.

In various embodiments, the conjugate image is obtained by dividing the luminance L of the color image obtained at 304 by the NIR at pixel level. In those embodiments, the conjugate image thus has an inverse relationship with the NIR- because at a given pixel, the higher luminance of that pixel in the NIR image is (for example, a vegetation pixel), the lower luminance of that pixel in the conjugate image as compared to some other pixels in the NIR. As an example, the bright vegetation in the NIR image, as can be seen, becomes darker as compared to other objects, such as the paved road, in the conjugate image shown in FIG. 4C. For instance, for a given pixel, such as the pixel 404 shown (which corresponds to the same part of the vegetation at pixels 402 and 502 in the NIR image shown in FIG. 4A and in the color image shown in FIG. 5A respectively), in the fused image within the vegetation parts, luminance value for that pixel in the conjugate image is actually quite low shown in FIG. 4C because it is an opposite of its counterpart pixel in the NIR image in luminance as explained above. Thus, during fusion, if that pixel’s luminance is determined according to the conjugate image rather than the NIR image, the brightness/color deviation of that pixel in the fused image can be reduced.

In one embodiment, the conjugate image is defined as

$$\frac{{L}^{2}}{N I R}$$

at pixel level. That is, in that embodiment, for a given pixel in the conjugate image such as pixel 404 shown, the square of Luminance of that pixel in the color image is divided by that pixel in the NIR image. In this embodiment, L square is selected for determining the conjugate image mainly for a consideration attenuation of the L in the color image for pixels. In this embodiment, the color image is in float values normalized between [0, 1]. At a given pixel such as pixel 404, the L square can attenuate luminance of that pixel (e.g., pixel 502) in the color image when the L value is small for that pixel. On the other hand, when the L value for that pixel is large (for example, close to 1), L square would not attenuate luminance of that pixel by very much. A result of this choice of using L square is that when such attenuation of the color image in the luminance channel is added to the NIR image at pixel level, the pixels will not saturate or become too bright to deviate the color - because the bright pixels in the color image are not attenuated by very much as explained above. It should be understood L square is merely a design choice for this embodiment according to the aforementioned principles. The choice of L square in this embodiment should not be construed as limiting the present disclosure. Other forms (formulas) of conjugate image obtained based on L and NIR in accordance with the present disclosure is also within the scope of present disclosure. For example, in some other examples, L cube, square root of L, L+ some weight, or any other formula involving L may be used instead of L square.

In various embodiments, pixels in the conjugate image are normalized to values between 0 and 1. Other ranges of the conjugate image are contemplated. In that embodiments, since NIR is a denominator, at pixels where the NIR is 0, the above division may be invalid due to infinity division by 0. In that embodiment, for those pixels, the above division is skipped and their values are set to 0 in the conjugate image. Below is an example of pseudo code for this embodiment: For each pixel in the conjugate image{ Determine if the pixel in the NIR is 0{ If Yes: set the pixel to 0 If No: obtain L of that pixel in the color image; set the pixel to

$$\frac{{L}^{2}}{N I R} ;$$

and normalize the pixel to a value between 0 and 1}} It should be understood, this formula is just one embodiment of obtaining the conjugate image in accordance with the present disclosure. Other embodiments are contemplated. For example, in some other embodiments, a different formula may be used to create at least one opposing color/brightness characteristics in the conjugate image as compared to the NIR image.

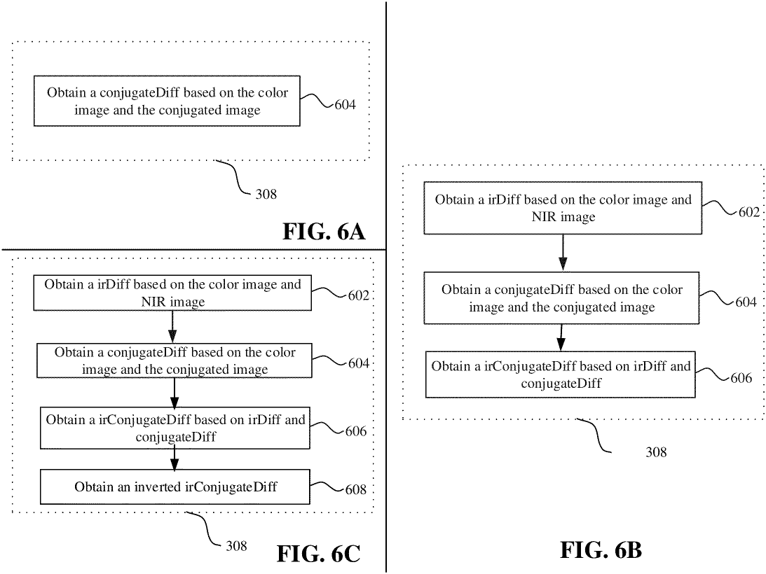

At 308, a weight can be obtained based on the conjugate image obtained at 306. As mentioned above, the weight obtained at 308 is for reducing certain aspects of the NIR image during the image fusion using the NIR image. FIG. 6 illustrates three different embodiments of operations at 308. Other embodiments are contemplated.

Attention is now directed to FIG. 6A, where one embodiment for obtaining a weight based on the conjugate image is illustrated. As can be seen, in this embodiment, at 604, for a given pixel such as pixel 404 in the conjugate image shown in FIG. 4C, a difference between the conjugate image and the luminance of the color image can be determined as a weight at that pixel. As used herein, this difference may be referred to as conjugateDiff. In one embodiment, for the given pixel, the conjugateDiff is obtained by L of that pixel in the color image - that pixel’s luminance in the conjugate image. In that embodiment, the so determined conjugateDiff is cut off at 0 and is normalized to values between 0 and 1. Other ranges of conjugateDiff are contemplated. An example image obtained as conjugateDiff from the color and conjugate images is illustrated in FIG. 4D.

In accordance with the present disclosure, conjugateDiff can be used to preserve details for a high IR emission part in the color image so they are less biased towards the NIR image, while add details from the NIR image for non-vegetation parts. Such a part may include a vegetation part (e.g., trees, grasses, plants), bright color objects (e.g., a red roof, bright color clothing) and/or any other high emission part. For example, use a given pixel in the fused image as an illustration, such as pixel 406 shown in FIG. 4D. If the pixel is within vegetation parts in the fused image shown in FIG. 4D, luminance value for that pixel in the conjugate image (e.g., pixel 404) is actually quite low because it is an opposite of its counterpart pixel in the NIR image in luminance as explained above. Thus, if conjugateDiff is applied to this pixel in the fused image in the luminance channel (instead of NIR), this pixel is less biased towards NIR and more consistent with its counterpart pixel in the color image as compared to many existing image fusion methods. On the other hand, if the given pixel is within non-vegetation parts of the fused image, its conjugateDiff is more or less the same as NIR. Thus, its counterpart pixel in the fused image would be enhanced by NIR after conjugateDiff is applied to that pixel in the fused image. FIG. 5C illustrates one example of a fused image by using conjugateDiff as a luminance channel, combined with the color image’s a*b* color channels.

FIG. 6B illustrates another embodiment for obtaining a weight based on the conjugate image. At 602, an emission difference (referred to as irDiff herein) can be determined for a given pixel based on the color image and NIR image. US Patent Application number #63/113,151, entitled “Color Image & Near-Infrared Image Fusion with Base-Detail Decomposition and Flexible Color and Details Adjustment”, describes various embodiments for determining the irDiff. As mentioned above, US Patent Application number #63/113,151 is incorporated by reference in its entirety herein. In one embodiment, the irDiff is determined based on a difference between the NIR image and the L obtained from the color image at step 304 in a luminance channel. In various embodiments, the irDiff is cut off at 0 and is normalized between 0 and 1. However, this is not intended to be limiting the value of irDiff. Other ranges of irDiff are contemplated. In FIG. 4B, an example of irDiff based on the NIR image of the scene shown in FIG. 4A is illustrated.

At 604, conjugateDiff is obtained for a given pixel as explained above. Details are not repeated.

At 606, a difference (referred to as irConjugateDiff herein) between conjugateDiff and irDiff can be obtained for a given pixel, such as pixel 502 shown in the color image shown in FIG. 5A. In one embodiment, irConjugateDiff is obtained simply by subtracting irDiff from conjugateDiff as conjugateDiff - irDiff. In that embodiment, the irConjugateDiff is set to 0 when its value is negative and otherwise is normalized to values between 0 and 1. Other ranges of irConjugateDiff are contemplated FIG. 4E illustrates one example of irConjugateDiff.

One motivation behind obtaining irConjugateDiff is that such a value can help reduce bright/color deviation brought by high IR emission parts in the NIR image. Typically, for a high emission pixel, the following is true: NIR>L>conjugate image. That is, luminance for this type of pixel is higher in the NIR image than that in the color image, which is higher than that in the conjugate image. Thus, for this type of pixel, irDiff is typically larger than or equal to conjugateDiff, which can result in irConjugateDiff being less than or equal to 0. Thus, for this type of pixel, irConjugateDiff is desired during the image fusion to cause NIR to contribute nothing to this pixel. On the other hand, for a low IR emission pixel, irDiff is low, which is typically close to 0. For this type of pixel, thus, irConjugateDiff would approximate conjugateDiff, which as explained above can be used, for example, to preserve the pixel brightness in the color image during image fusion.

In some embodiments, operation(s) at 308 for obtaining a weight may involve obtaining an inverted irConjugateDiff such as the step 608 as shown in FIG. 6C. This can facilitate visualization of vegetation in the image to be weighed out as white pixels. In one embodiment, inverted irConjugateDiff is obtained by 1 - irConjugateDiff. FIG. 4F illustrates one example of an image obtained through an inverted irConjugateDiff in accordance with the disclosure.

Having described different embodiments for step 308, attention is now directed back to FIG. 3. At 310, the weight obtained at 308 may be applied when producing a fused image of the color image and the NIR image. For example, irDiff, conjugateDiff, irConjugateDiff and/or any other weighs can be applied during the image fusion. In various embodiments, such weights may be used for blending the color image and NIR image during the image fusion process. For example, such weights may be used for assigning percentages of luminance in the fused image coming from the color image and the NIR image at pixel level. FIG. 5B illustrates one example of a fused image obtained by applying irDiff as a binary weight to the fused image. In that example, any value greater than 0 in the irDiff is mapped to 1, otherwise to 0. FIG. 5C illustrates one example of a fused image by using conjugateDiff as a luminance channel, combined with the color image’s a*b* color channels.

In various embodiments, irConjugateDiff may also be applied as a weight during the image fusion. In those embodiments, the irCongjugateDiff may produce a better result for the fused image (in terms of less color/brightness deviation in high IR emission parts) than congjugateDiff due to further processing being taken for irConjugateDiff to differentiate high IR emission pixels from low IR emission pixels as explained above. FIG. 5D illustrates one example of a fused image by using irConjugateDiff. In this example, irConjugateDiff and inverted irConjugateDiff are used as weights according to the following formula when producing the fused image:

$$\left(1 - i r C o n j u g a t e D i f f\right) * L + i r C o n j u g a t e D i f f * N I R$$

such that the vegetation parts in the fused image is weighted towards that of the color image, and dehazing is achieved on the non-vegetation parts by weighting those zones towards the NIR image.As explained above, for high IR emission pixels (e.g., vegetation), NIR effects are undesired, which can be zeroed out using irConjugateDiff (i.e., irCongjugateDiff can be set to 0 for those pixels) as a weight. For those pixels, since irCongjugateDiff is set to 0, the inverted irConjugateDiff (i.e., 1- irConjugateDiff) is 1, which can be used to preserve the brightness of those pixels in the color image when producing the fused image. On the other hand, for low IR emission pixels, irConjugateDiff approximates conjugateDiff as explained above, which together with the inverted irConjugateDiff can be used to weight those pixels towards NIR in luminance channel so the brightness of NIR for those pixels are used when produced the fusion image. As can be seen, the vegetation in the fused images shown in FIGS. 5B-D are close to the color image while details are added to the haze zone in the background as compared to the fused image shown in FIG. 1C.

It should be understood, while the examples shown in FIGS. 3-5 focus on fusing an RGB color image and an NIR image, the technologies presented herein are applicable to any type of input images. For example, the color image can be any type of color image or monochrome image.

### III. Example Processor

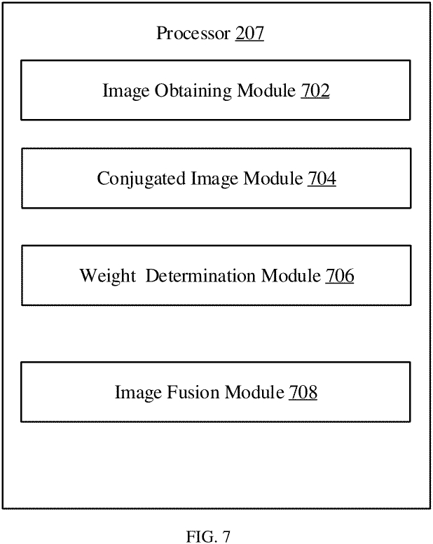

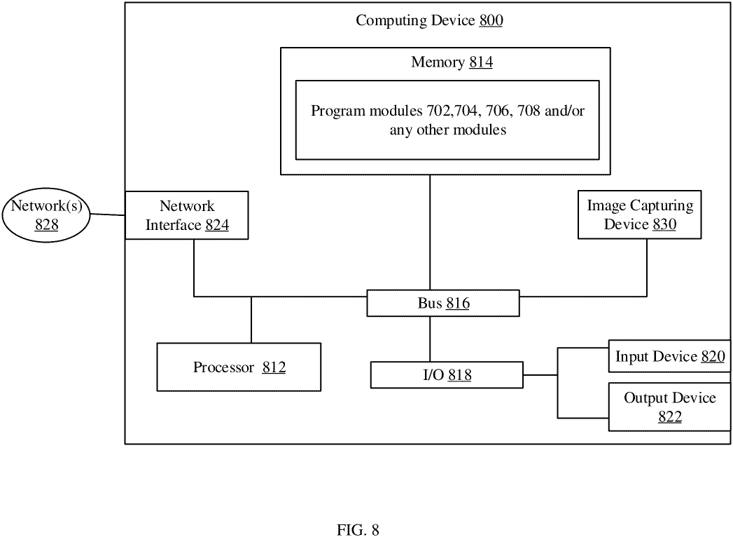

With an example Conjugate Image method having been described, attention is now directed to FIG. 7, where example details of the processor 206 are shown in accordance with the present disclosure. As mentioned, the processor 206 may configured to execute one or more computer program modules, which can include an image obtaining module 702, a irDiff determination module 704, a conjugate image module 706, an image fusion module 708, and/or any other modules. The image obtaining module 702 can be configured to obtain a first image and second image of a scene. In various embodiments, the first image obtained by the image obtaining module 702 is a color image of the scene and the second image obtained by the image obtaining module 702 is a NIR image of the scene. In one embodiment, the color image is an RGB image. In various embodiments, the image obtaining module 702 may be configured to convert the first image to a color space to separate a luminance of the first image. In some embodiments, the image obtaining module 702 may be configured to execute operations described herein in association with step 302 and step 304 shown in FIG. 3.

The conjugate image module 704 may be configured to obtain a conjugate image based on the second image. For achieving this, in various embodiments, the conjugate image module 704 may be configured to execute operations described in association with step 306 shown in FIG. 3.

The weight determination module 706 can be configured obtain a weight based on the conjugate image. For achieving this, in various embodiments, the conjugate image module 706 may be configured to execute operations described in association with step 308 shown in FIG. 3.

In some embodiments, weight determination module 706 may be configured to obtain a conjugateDiff based on the first image and the conjugate image. For achieving this, in various embodiments, the weight determination module 706 may be configured to execute operations described in association with step 604 shown in FIG. 6A.

In some embodiments, the weight determination module 706 may be configured to obtain an irDiff, irConjugateDiff and/or an inverted irConjugateDiff. For achieving this, in various embodiments, the weight determination module 706 may be configured to execute operations described in association with steps shown in FIGS. 6B-C.

The image fusion module 708 may be configured to fuse the first and second images to produce a fused image based on irDiff, conjugateDiff, irConjugateDiff, inverted irConjugateDiff, and/or any other weighs. For achieving this, in various embodiments, the conjugate image module 708 may be configured to execute operations described in association with step 310 shown in FIG. 3.

### IV. Computing System Example for Implementing the Conjugate Image Method in Accordance With the Present Disclosure

Any suitable computing system can be used for performing the operations described herein. For example, FIG. 8 depicts an example of a computing device 800 that can implement the device 200 shown in FIG. 2. In some embodiments, the computing device 800 can include a processor 812 that is communicatively coupled to a memory 814 and that executes computer-executable program code and/or accesses information stored in the memory 814. The processor 812 may comprise a microprocessor, an application-specific integrated circuit (“ASIC”), a state machine, or other processing device. The processor 812 can include any of a number of processing devices, including one. Such a processor can include or may be in communication with a computer-readable medium storing instructions that, when executed by the processor 812, cause the processor to perform the operations described herein.

The memory 814 can include any suitable non-transitory computer-readable medium. The computer-readable medium can include any electronic, optical, magnetic, or other storage device capable of providing a processor with computer-readable instructions or other program code. Non-limiting examples of a computer-readable medium include a magnetic disk, memory chip, ROM, RAM, an ASIC, a configured processor, optical storage, magnetic tape or other magnetic storage, or any other medium from which a computer processor can read instructions. The instructions may include processor-specific instructions generated by a compiler and/or an interpreter from code written in any suitable computer-programming language, including, for example, C, C++, C#, Visual Basic, Java, Python, Perl, JavaScript, and ActionScript.

The computing device 800 can also include a bus 816. The bus 816 can communicatively couple one or more components of the computing device 800. The computing device 800 can also include a number of external or internal devices such as input or output devices. For example, the computing device 800 is shown with an input/output (“I/O”) interface 818 that can receive input from one or more input devices 820 or provide output to one or more output devices 822. The one or more input devices 820 and one or more output devices 822 can be communicatively coupled to the I/O interface 818. The communicative coupling can be implemented via any suitable manner (e.g., a connection via a printed circuit board, connection via a cable, communication via wireless transmissions, etc.). Non-limiting examples of input devices 820 include a touch screen (e.g., one or more cameras for imaging a touch area or pressure sensors for detecting pressure changes caused by a touch), a mouse, a keyboard, or any other device that can be used to generate input events in response to physical actions by a user of a computing device. Non-limiting examples of output devices 822 include an LCD screen, an external monitor, a speaker, or any other device that can be used to display or otherwise present outputs generated by a computing device.

The computing device 800 can execute program code that configures the processor 812 to perform one or more of the operations described above with respect to FIGS. 1-5. The program code can include the image processing application 104. The program code may be resident in the memory 814 or any suitable computer-readable medium and may be executed by the processor 812 or any other suitable processor.

The computing device 800 can also include at least one network interface device 824. The network interface device 824 can include any device or group of devices suitable for establishing a wired or wireless data connection to one or more data networks 828. Non-limiting examples of the network interface device 824 include an Ethernet network adapter, a modem, and/or the like. The computing device 800 can transmit messages as electronic or optical signals via the network interface device 824.

The computing device 800 can also include image capturing device(s) 830, such as a camera or other imaging device that is capable of capturing a photographic image. The image capturing device(s) 830 can be configured to capture still images and/or video. The image capturing device(s) 830 may utilize a charge coupled device (“CCD”) or a complementary metal oxide semiconductor (“CMOS”) image sensor to capture images. Settings for the image capturing device(s) 830 may be implemented as hardware or software buttons. In some examples, the computing device 800 can include a regular color camera configured for capturing RGB color images and an NIR camera configured for capturing NIR images. The regular color camera and the NIR camera can be configured so that the fields of the view of the two cameras are substantially the same. In addition, the two cameras may have a matching resolution and have a synchronous image capturing from both sensors.

### V. General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

1. An electronically-implemented image processing method, performed by one or more of a processor, the image processing method comprising:
obtaining a first image and a second image, both the first image and the second image comprising a scene, and the first image comprising a first pixel and the second image comprising a second pixel, the first pixel and the second pixel corresponding to a first part in the scene;
obtaining a conjugate image based on the second image, wherein a third pixel in the conjugate image corresponds to the first part in the scene, and a luminance of the third pixel is less than a luminance of the second pixel;
obtaining a weight based on the conjugate image; and
fusing the first and second images to produce a fused image comprising the scene based on the weight, wherein for the part in the scene in the fused image, the fusing is biased towards the third pixel in the conjugate image in color, luminance, and/or any other aspects rather than the second pixel in the second image.

2. The electronically-implemented image processing method of claim 1, wherein obtaining the conjugate image based on the second image comprises: at the third pixel in the conjugate image, a luminance of third pixel is obtained by dividing a square of a luminance of the first pixel in the first image using a luminance of the second pixel.

3. The electronically-implemented image processing method of claim 1, wherein the first image is a color image comprising the scene and the second image is a near-infrared (NIR) image comprising the scene.

4. The electronically-implemented image processing method of claim 3, further comprising converting the first image to a color space to separate a luminance of the first image, wherein the color space is a L*a*b* (CIELAB (International Commission on Illumination Lab)) color space, L* represents the luminance of the first image, and a* and b* represent colors of the first image; and wherein, the part in the scene is a first part, and the scene comprises a second part, and at a fourth pixel corresponding to the second part, the fusing is biased towards L of the first pixel in the first image.

5. The electronically-implemented image processing method of claim 1, wherein obtaining the weight based on the conjugate image comprises:
for the part in the scene, obtaining a difference (conjugateDiff) between the first image and conjugate image in luminance; and wherein the fusing comprises:
for the part in the scene in the fused image, using conjugateDiff as the luminance.

6. The electronically-implemented image processing method of claim 5, wherein the conjugateDiff is obtained by subtracting the luminance of the third pixel in the conjugate image from the luminance of the first pixel in the first image.

7. The electronically-implemented image processing method of claim 1, wherein obtaining the weight based on the conjugate image comprises:
for the part in the scene:
obtaining an infrared emission difference (irDiff) between the first image and the second image;
obtaining, obtaining a difference (conjugateDiff) between the first image and conjugate image in luminance; and
obtaining a difference (irConjugateDiff) between conjugateDiff and irDiff; and; wherein the fusing comprises:
for the part in the scene in the fused image, applying the irConjugateDiff.

8. The electronically-implemented imaging method of claim 7, further comprising:
for the part in the scene:
obtaining an inverted irConjugateDiff; and, wherein the fusing further comprises:
for the part in the scene in the fused image, applying the inverted irConjugateDiff.

9. The electronically-implemented imaging method of claim 8, wherein the fusing for the part in the scene in the fused image comprises: using irConjugateDiff and inverted irConjugateDiff as weights according to the following formula:
(1 – irConjugateDiff) * L1 + irConjugateDiff * L2, wherein L1 represents a luminance of the first pixel in the first image, and L2 represents a luminance of the second pixel in the second image.

10. A device, comprising a first image sensor, a second image senor, and one or more of a processor, wherein:
the image sensor is configured to capture a first image;
the second image is configured to capture a second image; and
the processor is configured to perform;
obtaining the first image and a second image, both the first image and the second image comprising a scene, and the first image comprising a first pixel and the second image comprising a second pixel, the first pixel and the second pixel corresponding to a first part in the scene;
obtaining a conjugate image based on the second image, wherein a third pixel in the conjugate image corresponds to the first part in the scene, and a luminance of the third pixel is less than a luminance of the second pixel;
obtaining a weight based on the conjugate image; and
fusing the first and second images to produce a third image based on the weight, wherein for the part in the scene in the fused image, the fusing is biased towards the third pixel in the conjugate image in color, luminance, and/or any other aspects rather than the second pixel in the second image.

11. The device of claim 10, wherein obtaining the conjugate image based on the second image comprises: at the third pixel in the conjugate image, a luminance of third pixel is obtained by dividing a square of a luminance of the first pixel in the first image using a luminance of the second pixel.

12. The device of claim 10, wherein the first image is a color image comprising the scene and the second image is a near-infrared (NIR) image comprising the scene; and the processor is further configured to perform:
converting the first image to a color space to separate a luminance of the first image comprises covert the first image to a L*a*b* (CIELAB (International Commission on Illumination Lab)) color space, where L* represents the luminance of the first image, and a* and b* represent colors of the first image; and wherein, the part in the scene is a first part, and the scene comprises a second part, and at a fourth pixel corresponding to the second part, the fusing is biased towards L of the first pixel in the first image.

13. The device of claim 12, wherein obtaining the weight based on the conjugate image comprises:
for the part in the scene, obtaining a difference (conjugateDiff) between the color image and conjugate image in luminance; and wherein the fusing comprises:
for the part in the scene in the fused image, using conjugateDiff as the luminance.

14. The device of claim 13, wherein the conjugateDiff is obtained by subtracting the luminance of the third pixel in the conjugate image from the luminance of the first pixel in the first image.

15. The device of claim 10, wherein obtaining the weight based on the conjugate image comprises:
for the part in the scene:
obtaining an infrared emission difference (irDiff) between the first image and the second image;
obtaining, obtaining a difference (conjugateDiff) between the color image and conjugate image in luminance; and
obtaining a difference (irCongjugateDiff) between conjugateDiff and irDiff; and; wherein the fusing comprises:
for the part in the scene in the fused image, applying the irConjugateDiff.

16. The device of claim 15, further comprising:
for the part in the scene:
obtaining an inverted irConjugateDiff; and, wherein the fusing further comprises:
for the part in the scene in the fused image, applying the inverted irConjugateDiff.

17. The device of claim 16, wherein the fusing for the part in the scene in the fused image comprises: using irConjugateDiff and inverted irConjugateDiff as weights according to the following formula:
(1 – irConjugateDiff) * L1 + irConjugateDiff * L2, wherein L1 represents a luminance of the first pixel in the first image, and L2 represents a luminance of the second pixel in the second image.

18. A non-transitory medium storing executable instructions such that when the executable instructions are read by a processor, the processor is caused to perform:
obtaining a first image and a second image, both the first image and the second image comprising a scene, and the first image comprising a first pixel and the second image comprising a second pixel, the first pixel and the second pixel corresponding to a first part in the scene;
obtaining a conjugate image based on the second image, wherein a third pixel in the conjugate image corresponds to the first part in the scene, and a luminance of the third pixel is less than a luminance of the second pixel;
obtaining a weight based on the conjugate image; and
fusing the first and second images to produce a third image based on the weigh, wherein for the part in the scene in the fused image, the fusing is biased towards the third pixel in the conjugate image in color, luminance, and/or any other aspects rather than the second pixel in the second image.

19. The non-transitory medium of claim 18, wherein obtaining the conjugate image based on the second image comprises: at the third pixel in the conjugate image, a luminance of third pixel is obtained by dividing a square of a luminance of the first pixel in the first image using a luminance of the second pixel.

20. The non-transitory medium of claim 18, wherein obtaining the weight based on the conjugate image comprises:
for the part in the scene:
obtaining an infrared emission difference (irDiff) between the first image and the second image;
obtaining, obtaining a difference (conjugateDiff) between the color image and conjugate image in luminance;
obtaining a difference (irCongjugateDiff) between conjugateDiff and irDiff; and
obtaining an inverted irConjugateDiff;
and, wherein the fusing comprises:
for the part in the scene in the fused image, using irConjugateDiff and inverted irConjugateDiff as weights according to the following formula:
(1 – irConjugateDiff) * L1 + irConjugateDiff * L2, wherein L1 represents a luminance of the first pixel in the first image, and L2 represents a luminance of the second pixel in the second image.
